(19) United States
(12) Patent Application Publication
(10) Pub. No.: US 2010/0057758 A1
(43) Pub. Date: Mar. 4, 2010

(54) Alpha numeric media program stream selection

(76) Inventors: Susan Kirkpatrick, Rutherford, NJ (US); William Kirkpatrick, Rutherford, NJ (US)

Correspondence Address: Susan Kirkpatrick, 30 Donaldson Ave, Rutherford, NJ, 07070, US

(21) Appl. No.: 12/231,275

(22) Filed: Sep. 2, 2008

(51) Int. Cl. G06F 17/30

(52) U.S. Cl. 707/100; 707/E17.044

(57) ABSTRACT

Alpha Numeric Media Program Stream Selection uses a method of database lookup and conversion from easily human understood mnemonics to the computer machine level instructions necessary to present the desired programming for various media presentation devices. In one implementation, a portable and usually hand held device with both alphabetic and numeric keys that are available to use to input a user friendly name in alpha-numeric format, which said device then performs a conversion of the information input to send data from the handheld device to a media presentation device that instructs the media presentation device to select the corresponding media stream from several streams available to the media presentation device. In an alternate implementation, the user information would be transmitted from a portable and usually handheld device to the media presentation device without modification and database lookup would occur within the media presentation device. In an alternate implementation, the data input occurs on the media presentation device itself. An alternative implementation would add the ability to select a specific title of programming, and receive audio and/or visual feedback from the media presentation device regarding availability. In an alternative implementation, the user would be presented with a hierarchal menu structure guiding them to various programming selections by refining the selection at each menu level

### FIELD OF OUR INVENTION

Our invention pertains to the field of the selection of a particular media presentation available to a user, regardless of location of that program. Our invention more specifically relates to a human interface method to quickly and accurately obtain the desired stream from many that are available. Our invention most particularly allows for a program stream to be identified any way the stream creator desires, and enable an audience to easily select that stream on an appropriate media presentation device. A creator would be able to identify a program stream as “Hot 89”, with my invention converting the “Hot 89” keyboard entered data into tuning instructions for a frequency modulated radio media presentation device to tune to a signal at 89.3 Megahertz. The user would be freed of remembering that “Hot 89” is a local Frequency Modulated (FM) radio station transmitting on 89.3 Megahertz. The devices or media presentation device would also be updated frequently, so that any new program selection data would be available to the user quickly. Our invention also most particularly allows for that program to be delivered using any delivery technology available, switching between technologies as needed without user intervention.

### BACKGROUND OF OUR INVENTION

Almost everyone in the United States has the ability to receive two or more media streams simultaneously, using well known and understood methods such as an aural stream transmitted to them with Amplitude or Frequency Modulated radio signals (AM and FM radio), or a visual program stream with one or more related aural streams (Broadcast or Cable Television programmers) distributed to the population at large using methods such as local transmitters covering as allowed by the Federal Communications Commission, a state or locally franchised closed cable (Cable Television), and more recently, earth orbiting satellite relay systems, such as DirecTv® and EchoStar®. As those skilled in the art would appreciate, this is a small sample of the methods available for delivering a program stream from a creator to their desired audience and keeping it from others.

Many of these program streams are limited in the geographic area that they are distributed in. This has been due to the historic distribution model of a radio and television program stream creator using the transmission facilities of others in a network arrangement. While this allowed the program stream to be distributed in many areas at a low economic cost, this also created confusion when people traveled from one area of the country to another. A person's favorite television show could be on Channel 13 in New York, while it would also only be available on channel 2 in Boston. This situation has become much more aggravated with the introduction of local cable television distribution systems, where a programmer would be on three different channels in three different towns that border each other. When someone would visit to a nearby town, the cable television distributed entertainment accessing information would change in seemingly random order. The availability of competing delivery systems to some homes creates this confusion within the same house. If someone wants to watch a certain program stream named CNN on terrestrial cable, they would select channel 55. If they are watching the same stream on a satellite television, they would select channel 223, even if the television sets are physically next to one another. Historically, there has been little, if any, relationship between the technical receiving parameters and the program received, both within a small geographic area such as a state, or nationally. As people move around in an increasingly mobile society, and change program source providers such as changing from cable to satellite program delivery, they face a challenge of re-learning how the program provider that they want to watch is selected.

Program stream providers spend millions of dollars a year trying to build a brand, such as HBO® (Home Box Office) or TNT®, (Turner Network Television) hopefully one that the population at large will associate with desired programming and remember. In a competitive environment, some program stream owners will decide that they are best served by discarding the old image and creating a different image for their program stream, complete with different slogans and identifiers.

The closed distribution system, such as cable television, will desire to move the technical distribution parameters, such as channel, for various reasons. This represents a tremendous expense to the delivery system currently, as legally they must notify many people weeks and months prior to the change, and historically will receive customer service calls afterwards.

The ability of the internet to distribute programming using various audio and visual distribution technologies, such as Adobe, Inc.'s Flash technology, or Real Media's Real Player technology, has given the ability to create individual programs, and even complete program streams to millions of people in many countries. The ability for many people to easily select a desired program is a major problem for these program creators. These are some of the challenges that program stream providers face in attempting to entice an audience to select a given program stream provider instead of another for a period of time. What is needed is an easily used system that is the same in all locations and for all providers using any delivery method.

### Remote Control of Stream Selection

Remote control of television receivers was first introduced in the 1950's by Zenith Radio Corp. under the brand name “Space command”, and is now almost universally accepted. Remote control of AM and FM radio receivers is less common, as the receivers themselves are often reduced to the size of the remote control.

### Prior Art Offerings

Two different types of remote controls are most commonly used in the selection of television programming. One type is supplied by the manufacturer of the equipment (OEM), and extensively controls that particular piece of equipment, often times with unique codes transmitted from the portable device. The second type is sold to try to control many pieces of equipment, sold by many different manufacturers, which requires the user to tell the device which particular equipment to control. A recent trend has been for the manufacturer of the television set to try to build a device that controls many other pieces of equipment. None of these devices make the selection of the program stream any easier for the user, rather the user is still burdened with trying to remember a number to program stream conversion mentally.

Conversion charts are available to users, though having a conversion chart that has over a hundred program providers listed and indicating which number to enter to receive that program gets cumbersome, as the chart becomes larger and larger as technology advances and more streams can be provided to users, and entrepreneurs are providing programming on those available streams. Indeed, the program stream distribution industry is loath to have streams available and unused, as this represents lost revenue. The various program stream carriers, ie cable and satellite companies, typically provide these charts to users. Another major source of these charts are program listing services, which provide listings of programming available by time, and indicate a way of selecting the provider. Most of these services are regional in scope, covering the geographic area that is served by many program stream distribution services, and are of limited use on a distribution service other than the one intended. As an example, many newspapers have television listings that show what the cable television system receiving parameters, which are meaningless to a satellite distribution service subscriber.

### Definitions

Media selection control device: is a portable and usually handheld device that is used by a person to select the desired media that is sent to the media presentation device. A typical media selection device would be a portable television remote control.

Media presentation device: the various equipment used by a group or individual to convert the various media into human understandable form. A typical media presentation device would be a television monitor that converts the audio signal and video signals as its input into pictures and sound that humans can understand.

### BRIEF SUMMARY OF INVENTION

The user is presented with a small, portable and usually hand held controller that allows the user to select their desired media, without needing to know its delivery method, to their presentation device. A preferred embodiment would have the necessary receiving components built into the multi-media presentation device. An alternative device would have the necessary instructions and components in the hand held device. Another implantation would have the instructions and components in an intermediate device.

In one mode of use, the user would use the hand-held device to select the desired program stream provider. This information would be converted into the required information for the presentation device to show the user the desired program.

### DETAILED DESCRIPTION OF THE INVENTION

FIG. 1 shows a typical embodiment of the user device (100). The section shown in cross hatch is a typical television remote control, covered by many other patents, can vary in layout, form and function with affecting the improvement taught by this patent. The section shown below the typical controls (100A) is a full alpha-numeric so called QWERTY keyboard. In an alternative embodiment, user-programmable keys would be added to the keyboard.

FIG. 2 shows when a user presses, in order, the C-B-C keys, followed by the enter key, on the remote control (100) a command string would be emitted, using technologies such as infra-red transmission, or radio frequency transmission, from the remote controller to the media presentation device (200). The presentation device would receive the command, and process it in a microprocessor that would convert the received data (show C-B-C) into the predetermined receiving instructions to control the receiving section of the presentation device. If the presentation device was connected to the local community's cable television system, and that system carried CBC on RF channel 12, the microprocessor would receive the show C-B-C command and send to the radio frequency tuning section to receive the signal on channel 12. Unbeknownst to the user, a different user selection may have much more complex receiving instructions, or the receiving instructions may have changed for any reason.

While the preferred embodiment would have the controller in the presentation device itself, there is no requirement that this happen. In an alternative embodiment, the receiver, remote control decoder, database and the user would still be presented with the desired programming without any change in their method of use of the invention.

FIG. 3 shows the remote control presentation command signal flow. The command is issued by the controller (100), and is received using complementary technology (300). If the controller sends infrared, then the sensor (300) would be an infrared sensor. The sensor outputs an electric signal compatible with the processing section, that contains the user's selection command. The processor (301) performs a database lookup, using a database that has been stored in memory (302), to determine the reception data needed to select the desired presentation. This reception data is then sent to the incoming media selection (303), where the desired signal is selected from the many presented, or send commands that are needed to be fed to other devices to effect the selection.

### BRIEF DESCRIPTION OF THE SEVERAL VIEWS OF THE DRAWING

A person skilled in the art would appreciate that this is a very simplistic example,

FIG. 1 depicts a typical media remote control. The crosshatched area is the prior art offerings, 100A highlights the claimed invention area: the addition of an alphanumeric keyboard to the remote-control device.

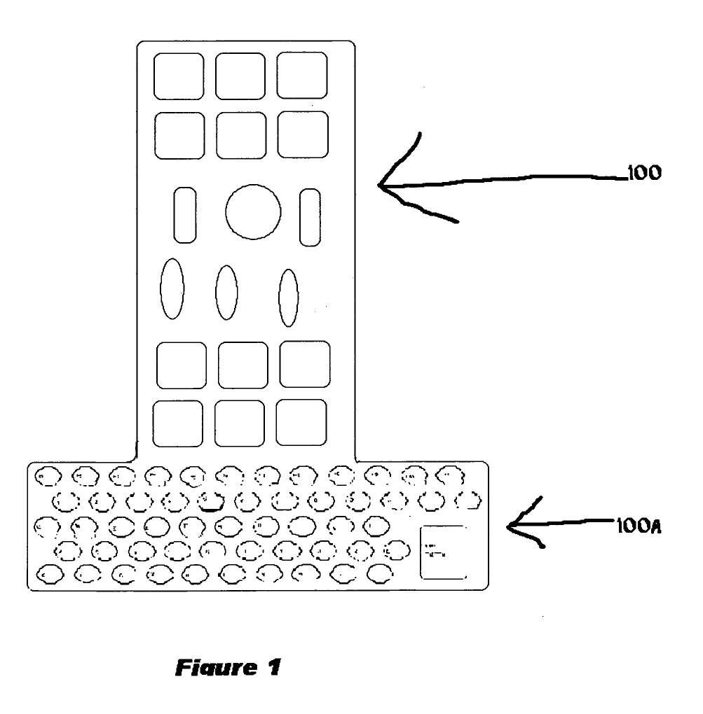

FIG. 2 shows the typical use of the remote control. In typical use 100 is the remote-controller of 200 the media presentation device.

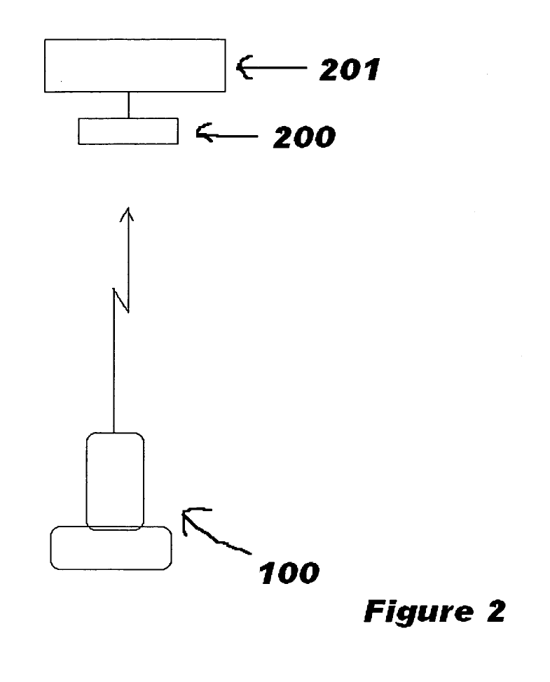

FIG. 3 is a detailed breakdown of the reception of the command signals coming into the media selection device, the processing that happens to select the desired media stream to send to the presentation device.

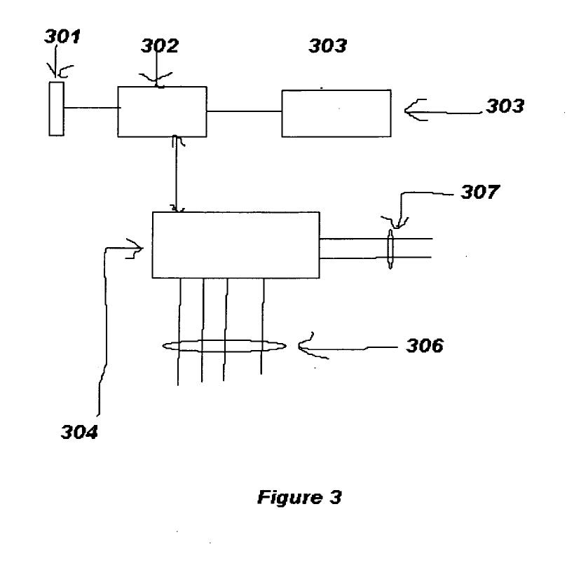

FIG. 4 is a more close-up detail of the media section device showing various inputs of media and control to obtain the output of the desired media going to a presentation device

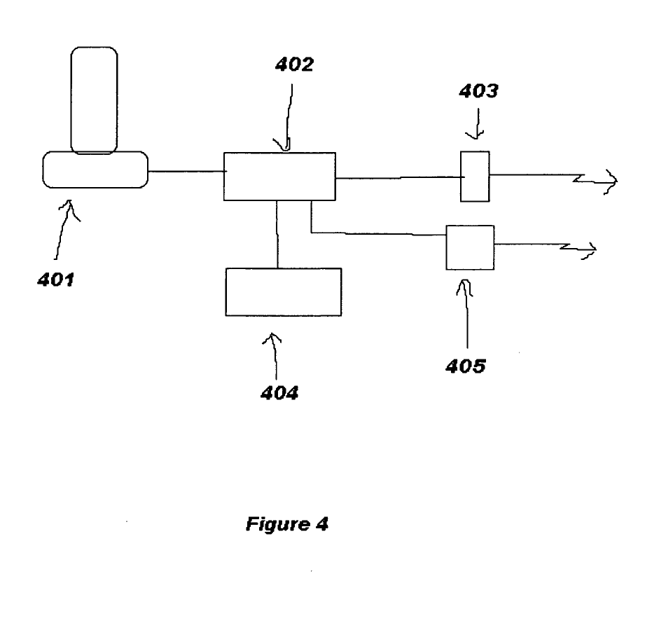

For our invention, We claim

1. a database containing fields of data used to associate alpha-numeric character strings to the technical parameters used to receive a particular media stream or file

2. the database in claim 1 being populated by receiving Transmission Stream Identifiers located in the data stream of terrestrial broadcast television stations as specified by the Advanced Television systems Committee and accepted by the Federal Communications Commission, and associating that identifying alpha numeric data string with the receiving data needed to locate the media associated with that particular identifier,

3. the database in claim 1 being populated by receiving Transmission Stream Identifiers located in the data stream of cable television telecasts as specified by the Advanced Television systems Committee and accepted by the Federal Communications Commission, and associating that identifying alpha numeric data string with the receiving data needed to locate the media associated with that particular identifier,

4. the database in claim 1 being populated by receiving data send using an unrelated data transmission,

5. the database in claim 1 being populated by receiving data using the Internet from a data provider,

6. the database in claim 1 being stored in memory located in a portable device,

7. the database in claim 1 being stored in memory located in a media display device,

8. the database in claim 1 being stored in memory located in a media receiving device,

9. We claim the use of individual alpha numeric keys on a media selection input device.

10. We claim the ability of programming keys on a portable media receiver controlling device to send to the media receiving and display devices all the data required to display predetermined media.
